(19) United States
(12) Patent Application Publication
(10) Pub. No.: US 2025/0121881 A1
(43) Pub. Date: Apr. 17, 2025

(54) ELECTRONIC STEERING DEVICE AND OPERATING METHOD THEREOF

(71) Applicant: HL MANDO CORPORATION, Gyeonggi-do (KR)

(72) Inventors: Jaewoo LEE, Gyeonggi-do (KR); Donghoon SHIN, Seoul (KR); Jongchun WON, Gyeonggi-do (KR)

(21) Appl. No.: 18/401,339

(22) Filed: Dec. 30, 2023

(30) Foreign Application Priority Data
Oct. 13, 2023 (KR) 10-2023-0136662

(51) Int. Cl. B62D 6/00; B60W 60/00; B62D 5/04

(52) U.S. Cl. CPC B62D 6/008; B60W 60/001; B62D 5/046; B62D 6/001; B60W 2520/10; B60W 2540/18; B60W 2710/207

(57) ABSTRACT

The electronic steering device and the operating method thereof according to the present disclosure change the traveling direction of a vehicle using the same steering control method as that is a case where the vehicle is not operated in the autonomous driving mode even when the vehicle is operated in the autonomous driving mode, and thus vehicle safety can be improved since there is no movement difference between the steer wheel feedback actuator (SFA) and the road wheel actuator (RWA) during the mode switching process.

### TECHNICAL FIELD

The present disclosure relates to an electronic steering device and an operating method thereof.

### BACKGROUND

Unlike general-purpose steering devices, the steer-by-wire steering device which connects a steering wheel and a road wheel to each other through electrical signals includes a steer wheel feedback actuator (SFA) and a road wheel actuator (RWA). Since the SFA system and the RWA system are not mechanically connected to each other, the angle of the SFA and the position of the RWA can be changed according to different inputs. However, according to UN regulations, a traveling direction of a vehicle and a steering wheel angle must match when the speed of the vehicle is equal to or higher than a certain speed, and thus it is necessary to match the angles of the SFA and the RWA when the vehicle is operated in an autonomous driving mode. According to a conventional method, autonomous driving input is received as position information and input to the RWA, and when the RWA moves, the angle at which the RWA moves is inverted and the SFA is caused to move along the angle of the RWA. In this case, if the autonomous driving mode is stopped while the RWA moves and then the SFA inverts the current position and moves, there is a problem that there is a difference in the movement of the SFA and the RWA, resulting in a rapid vehicle behavior. That is, the RWA moves following the steering angle of the SFA when the vehicle is not operated in the autonomous driving mode (i.e., when the vehicle is operated in a normal mode), whereas the SFA changes the steering angle following the movement of the RWA when the vehicle is operated in the autonomous driving mode, and thus a difference in the movement of the SFA and the RWA occurs during mode switching.

### SUMMARY

An embodiment of the present disclosure provides an electronic steering device and an operating method thereof for changing a traveling direction of a vehicle using the same steering control method as that in a case where the vehicle is not operated in the autonomous driving mode even in a case where the vehicle is operated in the autonomous driving mode.

Objects to be achieved by the present disclosure are not limited to the above-mentioned objects and can be expanded in various ways without departing from the spirit and scope of the present disclosure.

An electronic steering device according to an embodiment of the present disclosure is an electronic steering device mounted on a vehicle, which includes a first ECU configured to control a steer wheel feedback actuator (SFA) in order to change a steering wheel angle on the basis of a steering control command provided from a vehicle ECU and to obtain a target rack position on the basis of the changed steering wheel angle in a case where the vehicle is operated in an autonomous driving mode, and a second ECU configured to control a road wheel actuator (RWA) in order to change a rack position on the basis of the target rack position provided from the first ECU.

Here, the first ECU may control the SFA in order to change the steering wheel angle to a target steering wheel angle obtained on the basis of the steering control command, detect the changed steering wheel angle, obtain the target rack position on the basis of the detected steering wheel angle using a two-dimensional lookup table, and provide the obtained target rack position to the second ECU.

Here, if the steering control command includes information regarding the steering wheel angle, the first ECU may obtain the information included in the steering control command as the target steering wheel angle.

Here, if the steering control command includes information regarding the rack position, the first ECU may obtain the target steering wheel angle on the basis of the information included in the steering control command.

Here, the first ECU may obtain the target steering wheel angle on the basis of the information included in the steering control command through inverse mapping of the two-dimensional lookup table.

Here, the first ECU may control the SFA in order to change the steering wheel angle to the target steering wheel angle obtained on the basis of the steering control command, and then provide the target rack position obtained on the basis of the detected steering wheel angle to the second ECU if a current speed of the vehicle is equal to or higher than a preset reference speed. Here, the first ECU may provide the target rack position obtained on the basis of the steering control command to the second ECU without performing the operation of controlling the SFA if the current speed of the vehicle is less than the reference speed.

Here, if the steering control command includes information regarding the steering wheel angle, the first ECU may obtain the target rack position on the basis of the information included in the steering control command using the two-dimensional lookup table.

Here, if the steering control command includes information regarding the rack position, the first ECU may obtain the information included in the steering control command as the target rack position.

Here, the first ECU may control the SFA in order to change the steering wheel angle on the basis of a steering wheel operation of a driver, obtain the target rack position on the basis of the changed steering wheel angle, and provide the obtained target rack position to the second ECU in a case where the vehicle is not operated in the autonomous driving mode.

A method of operating an electronic steering device according to an embodiment of the present disclosure is a method of operating an electronic steering device mounted on a vehicle, the method including a first step of controlling a steer wheel feedback actuator (SFA) in order to change a steering wheel angle on the basis of a steering control command provided from a vehicle ECU and obtaining a target rack position on the basis of the changed steering wheel angle in a case where the vehicle is operated in an autonomous driving mode and a second step of controlling a road wheel actuator (RWA) in order to change a rack position on the basis of the target rack position.

Here, the first step may include controlling the SFA in order to change the steering wheel angle to a target steering wheel angle obtained on the basis of the steering control command, detecting the changed steering wheel angle, and obtaining the target rack position on the basis of the detected steering wheel angle using a two-dimensional lookup table.

Here, the first step may include, if the steering control command includes information regarding the steering wheel angle, obtaining the information included in the steering control command as the target steering wheel angle.

Here, the first step may include, if the steering control command includes information regarding the rack position, obtaining the target steering wheel angle on the basis of the information included in the steering control command.

Here, the first step may include obtaining the target steering wheel angle on the basis of the information included in the steering control command through inverse mapping of the two-dimensional lookup table.

Here, the first step may include controlling the SFA in order to change the steering wheel angle to the target steering wheel angle obtained on the basis of the steering control command and then obtaining the target rack position on the basis of the detected steering wheel angle if a current speed of the vehicle is equal to or higher than a preset reference speed.

Here, the first step may include obtaining the target rack position on the basis of the steering control command without performing the operation of controlling the SFA if the current speed of the vehicle is less than the reference speed.

According to an embodiment of the present disclosure, even when a vehicle is operated in the autonomous driving mode, the traveling direction of the vehicle is changed using the same steering control method as that in a case where the vehicle is not operated in the autonomous driving mode, and thus vehicle safety can be improved because there is no movement difference between the SFA and the RWA (SFA) in the process of mode switching.

Effects according to various embodiments of the present disclosure are not limited to the effects described above, and it is clear to those skilled in the art that various effects are inherent in the present disclosure.

### BRIEF DESCRIPTION OF THE DRAWINGS

FIG. 1 is a block diagram illustrating an electronic steering device according to an embodiment of the present disclosure.

FIG. 2 is a block diagram illustrating the configuration of the electronic steering device shown in FIG. 1.

FIG. 3 is a diagram illustrating an inverse mapping algorithm according to an embodiment of the present disclosure.

FIG. 4 is a flowchart illustrating a method of operating the electronic steering device according to an embodiment of the present disclosure.

### DETAILED DESCRIPTION

An electronic steering device and an operating method thereof according to an embodiment of the present disclosure will be described in detail.

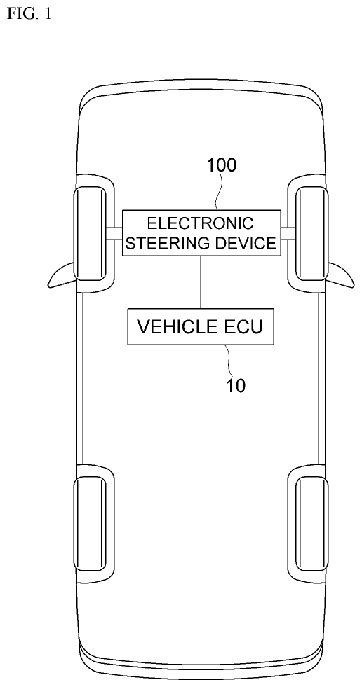

First, an electronic steering device according to an embodiment of the present disclosure will be described with reference to FIG. 1.

FIG. 1 is a block diagram illustrating an electronic steering device according to an embodiment of the present disclosure.

Referring to FIG. 1, the electronic steering device 100 according to an embodiment of the present disclosure is mounted on a vehicle and can change a traveling direction of the vehicle using a steer-by-steer method by which a steering wheel and a road wheel are connected to each other through electric signals.

In particular, even in a case where the vehicle is operated in the autonomous driving mode, the electronic steering device 100 may control a steering wheel angle on the basis of a steering control command provided from a vehicle electronic control unit (ECU) 10 and then control a rack position as in a case where the vehicle is not operated in the autonomous driving mode (that is, the vehicle is operated in the normal mode).

Accordingly, the electronic steering device 100 can change the traveling direction of the vehicle using the same steering control method as that in a case where the vehicle is not operated in the autonomous driving mode even when the vehicle is operated in the autonomous driving mode, and thus there is no movement difference between the SFA and the RWA in the process of mode switching, improving vehicle safety.

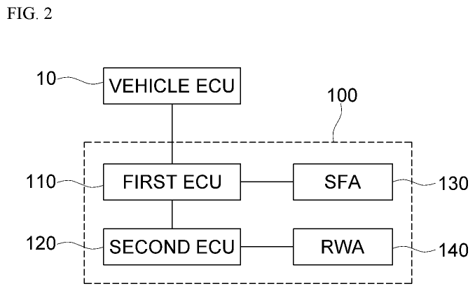

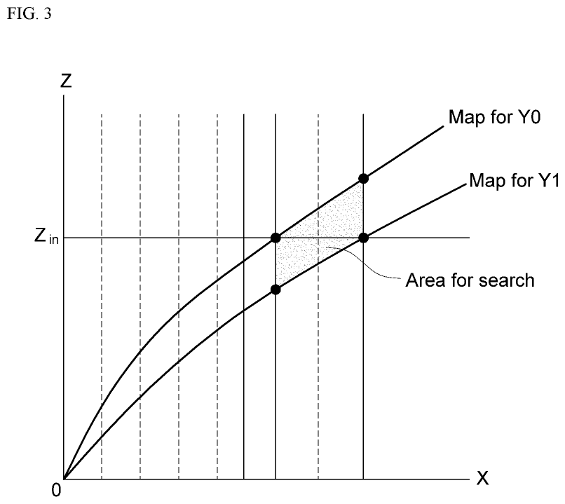

Next, the electronic steering device according to an embodiment of the present disclosure will be described in more detail with reference to FIGS. 2 and 3.

FIG. 2 is a block diagram illustrating the configuration of the electronic steering device shown in FIG. 1.

Referring to FIG. 2, the electronic steering device 100 may include a first ECU 110, a second ECU 120, an SFA 130, and an RWA 140.

A. In Case where Vehicle is Operated in Autonomous Driving Mode

In a case where a vehicle is operated in the autonomous driving mode, the first ECU 110 may control the SFA 130 in order to change a steering wheel angle on the basis of a steering control command provided from the vehicle ECU 10 and obtain a target rack position on the basis of the changed steering wheel angle.

That is, after the first ECU 110 controls the SFA 130 in order to change the steering wheel angle to a target steering wheel angle obtained on the basis of the steering control command, the first ECU 110 may detect the changed steering wheel angle, obtain a target rack position on the basis of the detected steering wheel angle using a preset two-dimensional lookup table, and provide the obtained target rack position to the second ECU 120.

Here, the two-dimensional lookup table may store information on the conversion relationship between steering wheel angles and rack positions. The first ECU 110 may obtain a rack position value corresponding to a specific value of the steering wheel angle through the two-dimensional lookup table.

Here, if the steering control command received from the vehicle ECU 10 includes information regarding a steering wheel angle, the first ECU 110 can obtain the information included in the steering control command as a target steering wheel angle.

In addition, if the steering control command received from the vehicle ECU 10 includes information regarding a rack position, the first ECU 110 may obtain a target steering wheel angle on the basis of the information included in the steering control command. That is, the first ECU 110 may obtain a target steering wheel angle on the basis of the information included in the steering control command through inverse mapping of the two-dimensional lookup table. A process of obtaining a steering wheel angle value corresponding to a specific value of rack position information through inverse mapping of the two-dimensional lookup table on the basis of the specific value of the rack position information included in the steering control command will be described below.

Meanwhile, the first ECU 110 may compare the current speed of the vehicle with a preset reference speed (e.g., 15 km/h, or the like) and operate in a first mode in which an operation of controlling the SFA 130 (i.e., an operation of changing the steering wheel angle) is performed→an operation of controlling the RWA 140 (i.e., an operation of changing the rack position) is performed according to the comparison result or in a second mode in which the operation of controlling the SFA 130 (i.e., an operation of changing the steering wheel angle) is not performed→the operation of controlling the RWA 140 (i.e., an operation of changing the rack position) is performed.

That is, if the current speed of the vehicle is equal to or higher than the reference speed, the first ECU 110 may control the SFA 130 in order to change the steering wheel angle to the target steering wheel angle obtained on the basis of the steering control command, and then provide the target rack position obtained on the basis of the detected steering wheel angle to the second ECU 120.

On the other hand, if the current speed of the vehicle is less than the reference speed, the first ECU 110 may provide the target rack position obtained on the basis of the steering control command to the second ECU 120 without performing the operation of controlling the SFA 130. Here, if the steering control command includes information regarding a steering wheel angle, the first ECU 110 may obtain the target rack position on the basis of the information included in the steering control command using the two-dimensional lookup table. If the steering control command includes information regarding a rack position, the first ECU 110 may obtain the information included in the steering control command as a target rack position.

The second ECU 120 may control the RWA 140 in order to change the rack position on the basis of the target rack position provided from the first ECU 110.

B. In Case where Vehicle is not Operated in Autonomous Driving Mode

In a case where the vehicle is not operated in the autonomous driving mode, the first ECU 110 may control the SFA 130 in order to change the steering wheel angle on the basis of a steering wheel operation of a driver, obtain a target rack position on the basis of the changed steering wheel angle, and provide the obtained target rack position to the second ECU 120.

In addition, the second ECU 120 may control the RWA 140 in order to change the rack position on the basis of the target rack position provided from the first ECU 110.

### C. Inverse Mapping Function of Two-Dimensional Lookup Table

FIG. 3 is a diagram illustrating an inverse mapping algorithm according to an embodiment of the present disclosure.

The first ECU 110 may obtain a steering wheel angle value corresponding to a specific value of rack position information using an inverse function of a lookup table using linear interpolation.

### C-1. Algorithm Overview

Referring to FIG. 3, the lookup table is a type of bi-linear transformation having inputs of X and Y. Therefore, if the value Y is fixed, the lookup table becomes an invertible and piece-wise linear function. If the value Y is constant, there are always two curves (a map for Y0 and a map for Y1). Therefore, points where the two curves intersect a line Zᵢₙ can be easily detected. Then, a solution Xₛₒₗ on the X-axis segment within the intersection points can be found.

### C-2. Definition

### <Symbol Definition>

Map[n,m]: n×m matrix data of lookup table
AX[m]: X-axis array of size m
AY[n]: Y-axis array of size n
Zᵢₙ: Interpolated value using map data Map[n,m]

### <Assumption>

An index value is zero-base. For example, when it is assumed that AX is [0 1 2], AX[0] is 0.

### <Function>

Result=DPSearch(Input, Array): DPSearch returns a result index indicating the position of Input within given Array. For example, if Array is [0, 10, 26, 36, 64], DPSearch(20, Array) returns “1”.

Result=Sat(Input, Max value): Saturation function. For example, Sat(10, 5) returns “5”, and Sat(1, 5) returns “1”.

### C-3. Definition of Some Values and Indices

I_{Y0}=DPSearch(Y,AY)

$${I}_{Y 1} = Sat ( {I}_{Y 0} + 1 , size of AY )$$

Y₀=AY[I_{Y0}]

Y₁=AY[I_{Y1}]

I_{XS}=DPSearch(Zᵢₙ,Map[I_{Y0},:])

I_{XE}=DPSearch(Zᵢₙ,Map[I_{Y1},:])

$${K}_{y} = ( Y - {Y}_{0} ) / ( {Y}_{1} - {Y}_{0} ) \\ {\overline{K}}_{y} = 1 - {K}_{y} , where 0 \leq {K}_{y} \leq 1.$$

I_{XS} and I_{XE} are indices corresponding to the intersection points between the curves for Y0 and Y1 and the line Zᵢₙ.

### C-4. Constraints for Zᵢₙ

$${Z}_{in} = ( Y - {Y}_{0} ) / ( {Y}_{1} - {Y}_{0} ) * \{ {F}_{1} - {F}_{0} \} + {F}_{0} = {K}_{y} {F}_{1} + {\overline{K}}_{y} {F}_{0} \\ {F}_{0} = ( {Z}_{1} - {Z}_{0} ) / ( {X}_{1} - {X}_{0} ) * ( {X}_{sol} - {X}_{0} ) + {Z}_{0} = {K}_{0} ( {X}_{sol} - {X}_{0} ) + {Z}_{0} \\ {F}_{1} = ( {Z}_{3} - {Z}_{2} ) / ( {X}_{1} - {X}_{0} ) * ( {X}_{sol} - {X}_{0} ) + {Z}_{2} = {K}_{1} ( {X}_{sol} - {X}_{0} ) + {Z}_{2}$$

Here, I_{Xsol} is an index indicating the solution Xₛₒₗ of this function.

I_{X0}=I_{Xsol}

$${I}_{X 1} = Sat ( {I}_{Xsol} + 1 , size of AX )$$

X₀=AX[I_{X0}]

X₁=AX[I_{X1}]

Z₀=Map[I_{Y0},I_{X0}]

Z₁=Map[I_{Y0},I_{X1}]

Z₂=Map[I_{Y1},I_{X0}]

Z₃=Map[I_{Y1},I_{X1}]

### C-5. Method

The following steps are attempted from I_{XS} to I_{XE} for each index.
1) A temporary data point of the current index Î_{X0} is calculated.

\hat{X}₀=AX[Î_{X0}]

\hat{X}₁=AX[Î_{X1}]

\hat{Z}₀=Map[I_{Y0},Î_{X0}]

\hat{Z}₁=Map[I_{Y0},Î_{X1}]

\hat{Z}₂=Map[I_{Y1},Î_{X0}]

\hat{Z}₃=Map[I_{Y1},Î_{X1}]

$${\hat{K}}_{0} = ( {\hat{Z}}_{1} - {\hat{Z}}_{0} ) / ( {\hat{X}}_{1} - {\hat{X}}_{0} ) \\ {\hat{K}}_{1} = ( {\hat{Z}}_{3} - {\hat{Z}}_{2} ) / ( {\hat{X}}_{1} - {\hat{X}}_{0} )$$

Here, Î_{X0}=Î_{Xsol}, and Î_{X1}=Sat(Î_{X0}+1, size of AX).
2) A temporary solution \hat{X}ₛₒₗ is calculated.

$${\hat{X}}_{sol} = {X}_{0} + ( {Z}_{in} - {K}_{y} {\hat{Z}}_{0} - {\overline{K}}_{y} {\hat{Z}}_{2} ) / ( {K}_{y} {\hat{K}}_{0} + {\overline{K}}_{y} {\hat{K}}_{1} )$$

3) If \hat{X}₀≤\hat{X}ₛₒₗ≤\hat{X}₁, \hat{X}ₛₒₗ becomes the actual solution Xₛₒₗ.
4) If the condition of 3) above is not satisfied, the same repetition is attempted for the next index.
5) A binary search algorithm can be used for repetition.

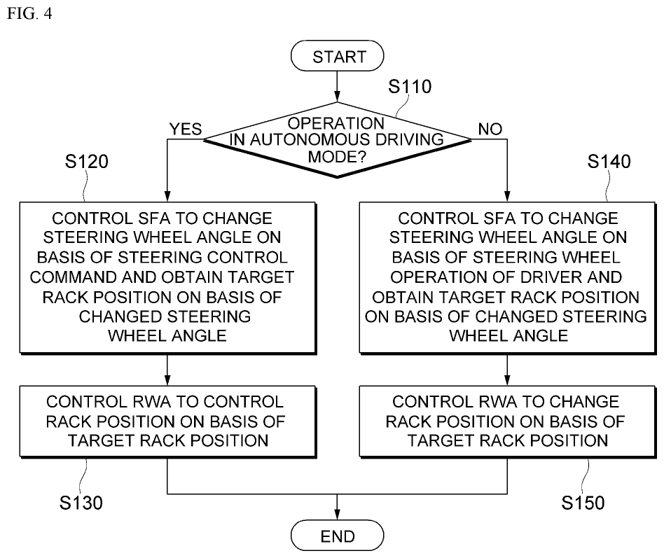

Next, a method of operating the electronic steering device according to an embodiment of the present disclosure will be described with reference to FIG. 4.

FIG. 4 is a flowchart illustrating a method of operating the electronic steering device according to an embodiment of the present disclosure.

Referring to FIG. 4, in a case where a vehicle is operated in the autonomous driving mode (S110—Y), the electronic steering device 100 may control the SFA 130 in order to change the steering wheel angle on the basis of a steering control command provided from the vehicle ECU 10 and obtain a target rack position on the basis of the changed steering wheel angle (S120).

That is, the electronic steering device 100 may control the SFA 130 in order to change the steering wheel angle to a target steering wheel angle obtained on the basis of the steering control command, detect the changed steering wheel angle, and obtain a target rack position on the basis of the detected steering wheel angle using a two-dimensional lookup table.

Here, if the steering control command provided from the vehicle ECU 10 includes information regarding a steering wheel angle, the electronic steering device 100 can acquire the information included in the steering control command as a target steering wheel angle.

If the steering control command provided from the vehicle ECU 10 includes information regarding a rack position, the electronic steering device 100 may obtain the target steering wheel angle on the basis of the information included in the steering control command. That is, the electronic steering device 100 can obtain the target steering wheel angle on the basis of the information included in the steering control command through inverse mapping of the two-dimensional lookup table.

Meanwhile, the electronic steering device 100 may compare the current speed of the vehicle with a reference speed and operate in the first mode in which an operation of controlling the SFA 130 (i.e., an operation of changing the steering wheel angle) is performed→an operation of controlling the RWA 140 (i.e., an operation of changing the rack position) is performed according to the comparison result or in the second mode in which the operation of controlling the SFA 130 (i.e., an operation of changing the steering wheel angle) is not performed→the operation of controlling the RWA 140 (i.e., an operation of changing the rack position) is performed.

That is, if the current speed of the vehicle is equal to or higher than the reference speed, the electronic steering device 100 may control the SFA 130 in order to change the steering wheel angle to the target steering wheel angle obtained on the basis of the steering control command, and then obtain a target rack position on the basis of the detected steering wheel angle.

On the other hand, if the current speed of the vehicle is less than the reference speed, the electronic steering device 100 may obtain the target rack position on the basis of the steering control command without performing the operation of controlling the SFA 130. Here, if the steering control command includes information regarding a steering wheel angle, the electronic steering device 100 may obtain the target rack position on the basis of the information included in the steering control command using the two-dimensional lookup table. If the steering control command includes information regarding a rack position, the electronic steering device 100 may obtain the information included in the steering control command as a target rack position.

Then, the electronic steering device 100 may control the RWA 140 in order to change the rack position on the basis of the target rack position (S130).

On the other hand, in a case where the vehicle is not operated in the autonomous driving mode (S110—N), the electronic steering device 100 may control the SFA 130 in order to change the steering wheel angle on the basis of a steering wheel operation of the driver and obtain a target rack position on the basis of the changed steering wheel angle (S140).

Then, the electronic steering device 100 may control the RWA 140 in order to change the rack position on the basis of the target rack position (S150).

Operations according to embodiments of the present disclosure may be implemented in the form of program instructions that can be executed through various computer means and recorded on a computer-readable storage medium. A computer-readable storage medium refers to any medium that participates in providing instructions to a processor for execution. A computer-readable storage medium may include program instructions, data files, data structures, or combinations thereof. Example of a computer-readable storage medium include a magnetic medium, an optical recording medium, a memory, and the like. A computer program may be distributed over computer systems connected via a network such that computer-readable code can be stored and executed in a distributed manner. Functional programs, code, and code segments for implementing the embodiments of the present disclosure can be easily deduced by programmers in the technical field to which the embodiments of this document belong.

The embodiments of the present disclosure are intended to explain the technical idea, and the scope of the technical idea of the embodiments of the present disclosure is not limited by these embodiments. The scope of protection of the embodiments of the present disclosure should be interpreted in accordance with the claims below, and all technical ideas within the equivalent scope should be interpreted as being included in the scope of rights of the embodiments of the present disclosure.

What is claimed is:

1. An electronic steering device mounted on a vehicle, the electronic steering device comprising:
a first ECU configured to control a steer wheel feedback actuator (SFA) in order to change a steering wheel angle on the basis of a steering control command provided from a vehicle ECU and to obtain a target rack position on the basis of the changed steering wheel angle in a case where the vehicle is operated in an autonomous driving mode; and
a second ECU configured to control a road wheel actuator (RWA) in order to change a rack position on the basis of the target rack position provided from the first ECU.

2. The electronic steering device of claim 1, wherein the first ECU controls the SFA in order to change the steering wheel angle to a target steering wheel angle obtained on the basis of the steering control command, detects the changed steering wheel angle, obtains the target rack position on the basis of the detected steering wheel angle using a two-dimensional lookup table, and provides the obtained target rack position to the second ECU.

3. The electronic steering device of claim 2, wherein, if the steering control command includes information regarding the steering wheel angle, the first ECU obtains the information included in the steering control command as the target steering wheel angle.

4. The electronic steering device of claim 2, wherein, if the steering control command includes information regarding the rack position, the first ECU obtains the target steering wheel angle on the basis of the information included in the steering control command.

5. The electronic steering device of claim 4, wherein the first ECU obtains the target steering wheel angle on the basis of the information included in the steering control command through inverse mapping of the two-dimensional lookup table.

6. The electronic steering device of claim 2, wherein the first ECU controls the SFA in order to change the steering wheel angle to the target steering wheel angle obtained on the basis of the steering control command, and then provides the target rack position obtained on the basis of the detected steering wheel angle to the second ECU if a current speed of the vehicle is equal to or higher than a preset reference speed.

7. The electronic steering device of claim 6, wherein the first ECU provides the target rack position obtained on the basis of the steering control command to the second ECU without performing the operation of controlling the SFA if the current speed of the vehicle is less than the reference speed.

8. The electronic steering device of claim 7, wherein, if the steering control command includes information regarding the steering wheel angle, the first ECU obtains the target rack position on the basis of the information included in the steering control command using the two-dimensional lookup table.

9. The electronic steering device of claim 7, wherein, if the steering control command includes information regarding the rack position, the first ECU obtains the information included in the steering control command as the target rack position.

10. The electronic steering device of claim 1, wherein the first ECU controls the SFA in order to change the steering wheel angle on the basis of a steering wheel operation of a driver, obtains the target rack position on the basis of the changed steering wheel angle, and provides the obtained target rack position to the second ECU in a case where the vehicle is not operated in the autonomous driving mode.

11. A method of operating an electronic steering device mounted on a vehicle, the method comprising:
a first step of controlling a steer wheel feedback actuator (SFA) in order to change a steering wheel angle on the basis of a steering control command provided from a vehicle ECU and obtaining a target rack position on the basis of the changed steering wheel angle in a case where the vehicle is operated in an autonomous driving mode; and
a second step of controlling a road wheel actuator (RWA) in order to change a rack position on the basis of the target rack position.

12. The method of claim 11, wherein the first step comprises controlling the SFA in order to change the steering wheel angle to a target steering wheel angle obtained on the basis of the steering control command, detecting the changed steering wheel angle, and obtaining the target rack position on the basis of the detected steering wheel angle using a two-dimensional lookup table.

13. The method of claim 12, wherein the first step comprises, if the steering control command includes information regarding the steering wheel angle, obtaining the information included in the steering control command as the target steering wheel angle.

14. The method of claim 12, wherein the first step comprises, if the steering control command includes information regarding the rack position, obtaining the target steering wheel angle on the basis of the information included in the steering control command.

15. The method of claim 14, wherein the first step comprises obtaining the target steering wheel angle on the basis of the information included in the steering control command through inverse mapping of the two-dimensional lookup table.

16. The method of claim 12, wherein the first step comprises controlling the SFA in order to change the steering wheel angle to the target steering wheel angle obtained on the basis of the steering control command and then obtaining the target rack position on the basis of the detected steering wheel angle if a current speed of the vehicle is equal to or higher than a preset reference speed.

17. The method of claim 16, wherein the first step comprises obtaining the target rack position on the basis of the steering control command without performing the operation of controlling the SFA if the current speed of the vehicle is less than the reference speed.

18. The method of claim 17, wherein the first step comprises, if the steering control command includes information regarding the steering wheel angle, obtaining the target rack position on the basis of the information included in the steering control command using the two-dimensional lookup table.

19. The method of claim 17, wherein the first step comprises, if the steering control command includes information regarding the rack position, obtaining the information included in the steering control command as the target rack position.

20. The method of claim 11, wherein the first step comprises controlling the SFA in order to change the steering wheel angle on the basis of a steering wheel operation of a driver and obtaining the target rack position on the basis of the changed steering wheel angle in a case where the vehicle is not operated in the autonomous driving mode.
